(19) United States
(12) Patent Application Publication
(10) Pub. No.: US 2025/0386177 A1
(43) Pub. Date: Dec. 18, 2025

(54) EMERGENCY CALL HANDLING BY USER EQUIPMENT WITH REDUCED CAPABILITIES IN BARRED CELLS

(71) Applicant: Apple Inc., Cupertino, CA (US)

(72) Inventors: Naveen Kumar R. Palle Venkata, San Diego, CA (US); Peng Cheng, Beijing (CN); Zhibin Wu, Los Altos, CA (US); Haijing Hu, Los Gatos, CA (US); Ping-Heng Kuo, London (GB); Ralf Rossbach, Munich (DE); Alexander Sirotkin, Tel Aviv (IL); Fangli Xu, Beijing (CN); Yuqin Chen, Beijing (CN)

(73) Assignee: Apple Inc., Cupertino, CA (US)

(21) Appl. No.: 18/862,515

(22) PCT Filed: Nov. 1, 2023
(86) PCT No.: PCT/CN2023/129125

§ 371 Date: Nov. 1, 2024

(51) Int. Cl. H04W 4/90; H04W 76/10

(52) U.S. Cl. CPC H04W 4/90; H04W 76/10

(57) ABSTRACT

The present application relates to devices and components including apparatus, systems, and methods to provide emergency calls for user equipments with reduced capabilities via barred cells in wireless communication systems.

### TECHNICAL FIELD

The present application relates to the field of wireless technologies and, in particular, to emergency call handling for user equipment having reduced capabilities in barred cells.

### BACKGROUND

Third Generation Partnership Project (3GPP) networks provide for user equipments (UEs) to operate with reduced capabilities for multiple reasons. For example, UEs are allowed to operate with a single reception chain and/or half-duplex operation for frequency division duplex (FDD). One or more of the cells within the 3GPP networks do not provide support for calls by UEs with reduced capabilities during normal operation. The UEs can determine that the cells that do not provide support are barred and can avoid utilizing the barred cells for calls.

### BRIEF DESCRIPTION OF THE DRAWINGS

FIG. 1 illustrates an example table of use case information in accordance with some embodiments.

FIG. 2 illustrates an example information block for cell barring in accordance with some embodiments.

FIG. 3 illustrates an example network arrangement in accordance with some embodiments.

FIG. 4 illustrates an example signaling chart in accordance with some embodiments.

FIG. 5 illustrates an example system information block 1 (SIB1) information element related to approach 5 in accordance with some embodiments.

FIG. 6 illustrates an example SIB1 information element related to approach 6 in accordance with some embodiments.

FIG. 7 illustrates an example SIB1 information element related to approach 7 in accordance with some embodiments.

FIG. 8 illustrates an example SIB1 information element related to approach 8 in accordance with some embodiments.

FIG. 9 illustrates an example procedure in accordance with some embodiments.

FIG. 10 illustrates an example procedure in accordance with some embodiments.

FIG. 11 illustrates an example procedure in accordance with some embodiments.

FIG. 12 illustrates an example user equipment (UE) in accordance with some embodiments.

FIG. 13 illustrates an example next generation NodeB (gNB) in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “based at least in part on” as used herein may indicate that an item is based solely on another item and/or an item is based on another item and one or more additional items. For example, item 1 being determined based at least in part on item 2 may indicate that item 1 is determined based solely on item 2 and/or is determined based on item 2 and one or more other items in embodiments.

The term “(e)RedCap UE” as used herein may refer to a reduced capability (RedCap) UE and/or an enhanced reduced capability (eRedCap) UE. For example, the statement that (e)RedCap UEs can access a cell can mean that both RedCap UEs and eRedCap UEs can access the cell.

During operation, user equipments (UEs) with reduced capabilities may determine one or more cells within a network are to be treated as barred based on the cells not supporting UEs with reduced capabilities. The UEs could avoid placing calls on the cells and/or the cells could prevent calls to be established for UEs with reduced capabilities. An issue could be presented when a UE with reduced capabilities is in a location where none of the available cells supported UEs with reduced capabilities. In legacy approaches, the UEs with reduced capabilities would be unable to perform calls, including emergency calls. Approaches described herein provide for allowing UEs with reduced capabilities to complete emergency calls with barred cells that do not provide support for non-emergency calls.

### Radio Access Network Work Group 2 (RAN2) Relevant Objectives From Study Item

A first identified objective (which can be referred to as Objective 1) may include to identify and study potential UE complexity reduction features, including [radio access network work group 1 (RAN1), RAN2] reduced number of user equipment (UE) reception (RX)/transmission (TX) antennas, UE Bandwidth reduction, half-duplex-frequency division duplex (FDD), relaxed UE processing time, and/or relaxed UE processing capability. As a note for UE bandwidth reduction, release 15 (Rel-15) synchronization signal block (SSB) bandwidth should be reused and layer 1 (L1) changes should be minimized.

A second identified objective (which can be referred to as Objective 2) may include to study UE power saving and battery lifetime enhancement for reduced capability UEs in applicable use cases (e.g., delay tolerant) [RAN2, RAN1], including reduced physical downlink control channel (PDCCH) monitoring by smaller numbers of blind decodes and control channel element (CCE) limits [RAN1]. Further, extended discontinuous reception (DRX) for radio resource control (RRC) Inactive and/or Idle [RAN2] may be studied.

### Further Analysis on Usage

User equipment within a network may include multiple different types of use cases. Types of use cases may include connected industry. The connected industry may include devices that are not part of ultra-reliable low latency communication (URLLC)/industrial internet-of-things (IIOT), but are present as part of the connected industry. The devices may be not very latency critical, stationary (low mobility), and/or low complexity in terms of capabilities and hardware.

Another type of use case may include surveillance. Surveillance may be very similar to requirements of connected industry, but with higher UL data rates.

Another type of use case may include wearables. Wearables may have higher uplink (UL)/downlink (DL) data rates, mobility can be comparable to regular UEs, may have high power saving requirements, and/or may have lower hardware complexity as well.

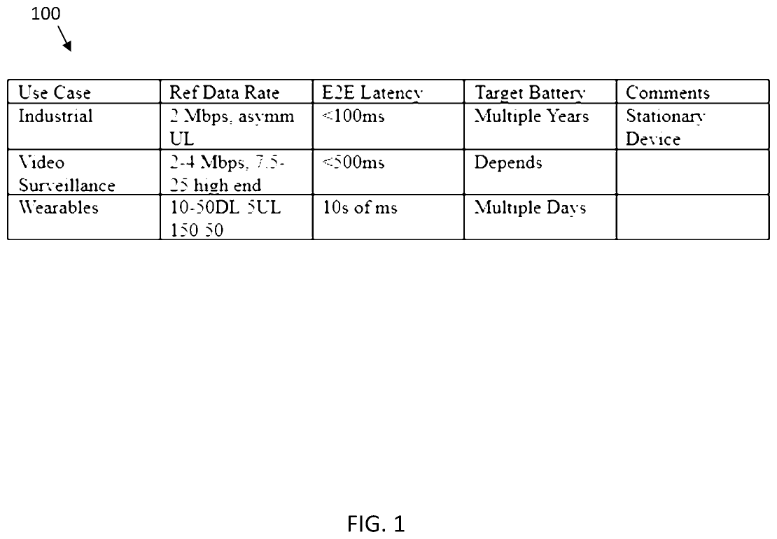

FIG. 1 illustrates an example table 100 of use case information in accordance with some embodiments. For example, the table 100 illustrates information for the different use cases described above.

### Enhanced Reduced Capability (eRedCap) Information

eRedCap is planned release (Rel-18) feature where further reduction in capability (compared to RedCap release (R17) devices) is planned. eRedCap may have further reduced UE complexity in frequency range FR1 [RAN1, RAN2, RAN4]. UE broadband (BB) bandwidth reduction may be implemented. The reduced UE BB bandwidth may include 5 megahertz. (MHz) BB bandwidth only for physical downlink shared channel (PDSCH) (for both unicast and broadcast) and physical uplink shared channel (PUSCH), with 20 MHz radio frequency (RF) bandwidth for UL and DL. The other physical channels and signals may still be allowed to use a bandwidth part (BWP) up to the 20 MHz maximum UE RF+BB bandwidth.

eRedCap may have UE peak data rate reduction. Relaxation of the constraint (vLayers·Qm·f≥4) for peak data rate reduction may be implemented. The relaxed constraint may be, e.g., 1 (instead of 4). The parameters (vLayers, Qm, f) can be as in release 17 (Rel-17) RedCap.

Both 15 kHz SCS and 30 kHz SCS may be supported. The legacy UE capability framework may be used, and changes to capability signaling may be specified only if necessary. By default, all UE capabilities applicable to a Rel-17 RedCap UE may be applicable unless otherwise specified.

### Cell Barring by the UE-legacy RAN2 logic

If the UE cannot support ‘basic’ DL and UL capabilities to support a CONNECTED mode session, the UE may bar cells. Some of the capabilities may include unsupported channel bandwidth, including carrier as well as BWP bandwidth. Further some of the capabilities may include unsupported sub-carrier spacing for the operating frequency/bandwidth (BW).

Features that a cell does not support may include non-terrestrial network (NTN) support and/or subcarrier offset for reduced capability (RedCap). Features that a cell does not want UEs to operate in may include, for RedCap UEs, 1Rx chain UEs and/or 2Rx chain UEs. Features that a cell does not want UEs to operate in may include, for enhanced reduced capability (eRedCap) UEs, 1Rx chain UEs and/or 2Rx chain UEs. Further, features that a cell does not want UEs to operate in may include half-duplex operation, which can be the same for both RedCap and eRedCap.

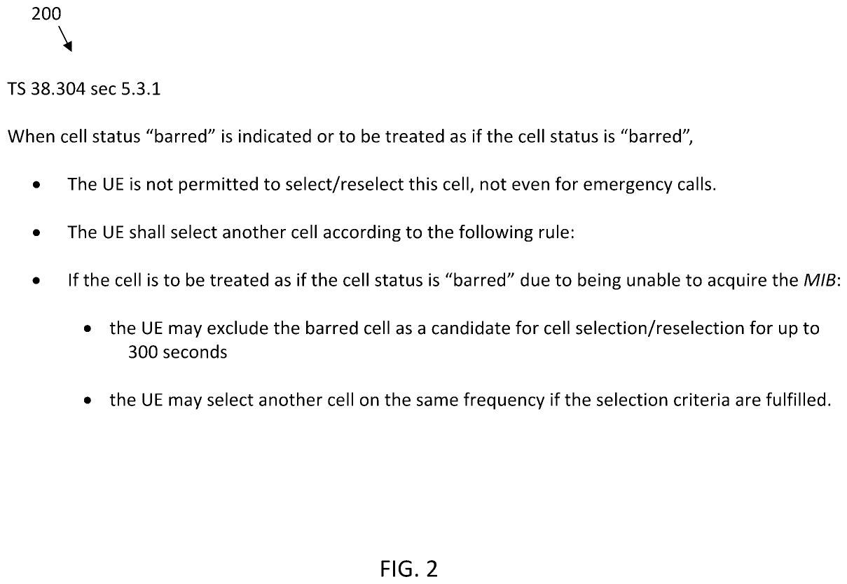

UE is expected to ‘bar’ the cell that does not support reduced features of the UE. UE is not allowed to make an emergency call on these cells in legacy embodiments. FIG. 2 illustrates an example information block 200 for cell barring in accordance with some embodiments. For example, the information block 200 provides information about when a UE may treat a cell as barred (for example, assign barred status to the cell) and/or operation of the UE with respect to the barred cell.

### Issue Statement

Many wearable type UEs are RedCap UEs and eRedCap UEs. They may provide voice services to the user. Should be able to allow placing emergency calls!

In the legacy case where the (e)RedCap UE has to ‘bar’ the cell due to not wanting a sub-feature of the UE, the UE misses out on providing EM call services to the user. It is critical that the emergency (EM) calls are handled when the network NW ‘can’ handle it! For example, NW should be able to use 1Rx (single multiple input multiple output (MIMO) layer) for handling internet protocol multimedia subsystem (IMS) based EM call even when NW prefers 2Rx (e)RedCap UEs. Further, ability for scheduling DL/UL in a half-duplex manner for the IMS based EM call should be supported by the NW. Legacy approaches do not provide for EM calls in the cases. How to address the issue? Approaches described herein provide options for approaching the issue of supporting EM calls for eRedCap UEs and/or RedCap UEs.

### Approaches

### UE IDLE Mode Behavior

Once UE is powered on “or” moves from CONNECTED mode to IDLE (to INACTIVE) UE may be in an ‘Any cell selection state’. UE may search for cells (technical specification (TS) 38.304—section (sec) 5.2.7/5.2.8) (Technical Specification 38.304 (3^{rd} Generation Partnership Project; Technical Specification Group Radio Access Network; NR; User Equipment (UE) procedures in Idle mode and RRC Inactive state (Release 17). (2023). 3GPP TS 38.304, 17.6.0). The aim of the search may be to find a suitable cell. If found, the UE may move to ‘camped normally’ state. If suitable cell is not found, the UE may aim to find an acceptable cell. If acceptable cell is NOT found, the UE may move to ‘camp on any cell’ state and continue to be in this state. It is expected that UE may try searching again based on external trigger (for example, when a user places a call, or periodic).

An acceptable cell may be a cell is not barred (as defined by TS 38.304, sec 5.3.1). The cell selection criteria may be fulfilled (as defined by TS 38.304, sec 5.2.3.2).

A suitable cell may be a cell is not barred (as defined by TS 38.304, sec 5.3.1). The cell selection criteria may be fulfilled (as defined by TS 38.304, sec 5.2.3.2). The cell may be part of a registered public land mobile network (PLMN), and there may be other requirements.

### Approach Direction in Using UE IDLE Mode Behavior

An aim may include that an approach should be simple with minimal UE procedural change. Further, an aim may be that the approach is backward compatible. This may allow R17 UEs to implement the change, if the change request (CR) is introduced from Rel-18.

The approach direction may be to allow the UE to consider the cell it has barred as ‘acceptable’ cell. The next set of approaches propose multiple ways/methods utilizing the above logic.

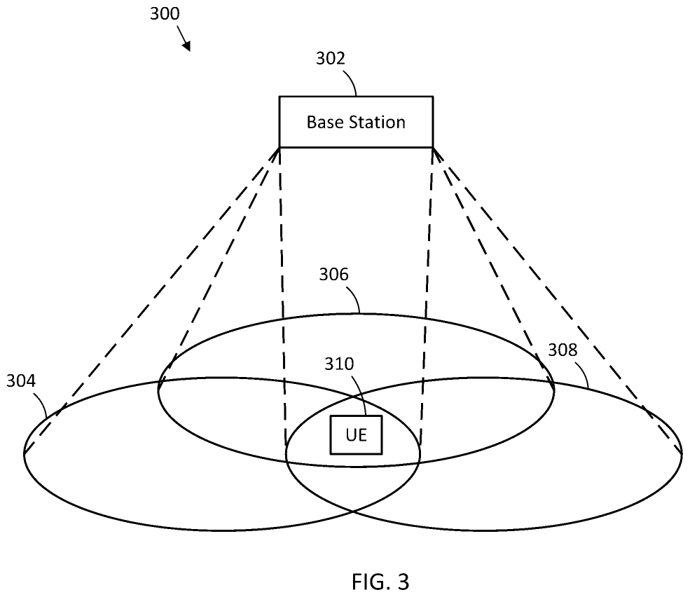

FIG. 3 illustrates an example network arrangement 300 in accordance with some embodiments. The approaches described throughout this disclosure may be implemented within the network arrangement 300. For example, a network, or portion thereof, illustrated by the network arrangement 300 may implement one or more of the approaches described throughout this disclosure to provide emergency support for emergency calls to be made by UEs via a barred cell.

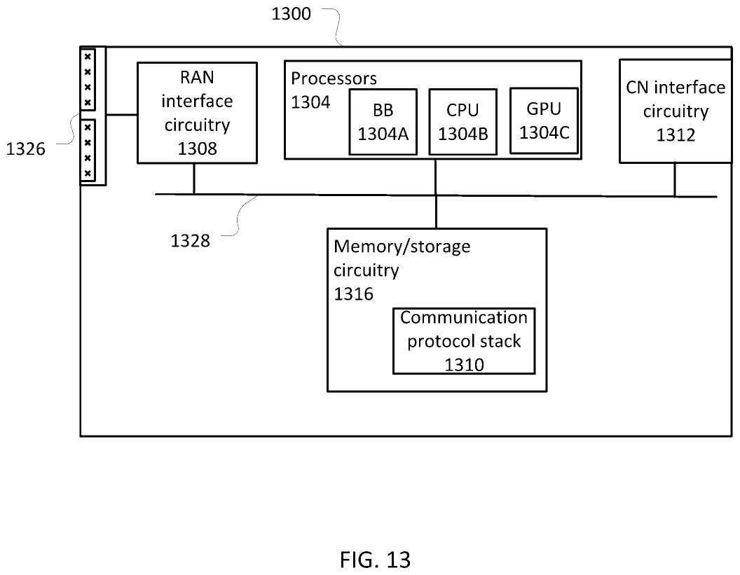

The network arrangement 300 may include a base station 302. The base station 302 may include one or more of the features of the next generation NodeB (gNB) 1300 (FIG. 13). The base station 302 may be coupled to, or may include at least a portion of, a core network of a network that can provide services to UEs.

The base station 302 may host one or more cells. For example, the base station 302 hosts a first cell 304, a second cell 306, and a third cell 308 in the illustrated embodiment. Each of the cells may define an area in which services can be accessed by UEs. The areas of the cells may overlap, as shown in the illustrated embodiment.

Each of the cells may have different capabilities, where one or more of the cells may not support certain capabilities. For example, one or more of the cells may not support UEs operating with 1RX chain and/or may not support UEs operating with half duplex for frequency division duplex (HD-FDD), at least for non-emergency calls.

The network arrangement 300 may include a UE 310. The UE 310 may be a RedCap UE or an eRedCap UE. The UE 310 may be located in one or more cells. For example, the UE 310 is located in the first cell 304, the second cell 306, and the third cell 308 in the illustrated embodiment. The UE 310 may attempt to connect with the network (such as via the base station 302) and/or may gather information about the different cells in which the UE 310 is located from the network (such as via the base station 302).

The UE 310 may receive a system information block 1 (SIB1) that provides information for a cell in which the UE 310 is located. For example, the UE 310 may receive an SIB1 for each cell that the UE 310 is seeking information and/or may receive a single SIB1 that provides information for multiple cells. The UE 310 may determine if a cell, or which of the cells, supports the requirements of the UE 310, such as the 1RX chain and/or HD-FDD requirement of the UE 310. If the UE 310 determines a cell does not support a requirement of the UE 310, the UE 310 may treat the cell as barred (which may be referred to as a barred cell). For example, if the first cell 304 does not support a requirement of the UE 310, the UE 310 may treat the first cell 304 as a barred cell. While the UE 310 may be prevented from establishing non-emergency calls via a barred cell, approaches described herein provide instances where the UE 310 may establish emergency calls via a barred cell.

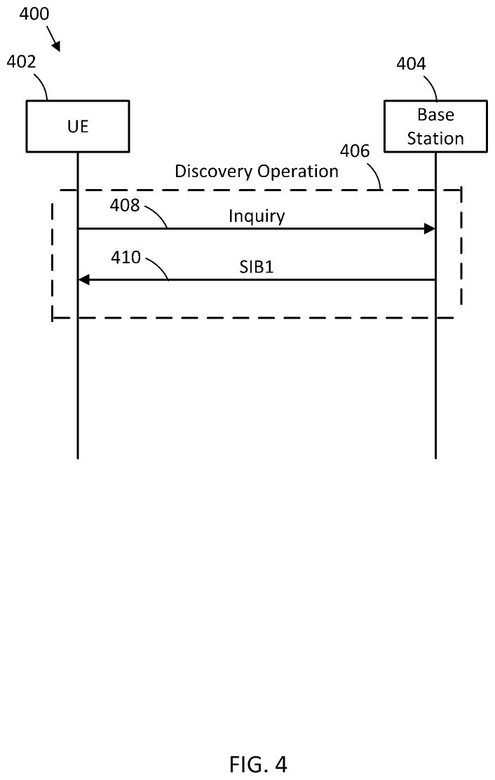

FIG. 4 illustrates an example signaling chart 400 in accordance with some embodiments. The signaling chart 400 illustrates operations, signals, and/or elements that can be exchanged between a UE (such as the UE 310 (FIG. 3)) and a base station (such as the base station 302 (FIG. 3)) in accordance with approaches described herein.

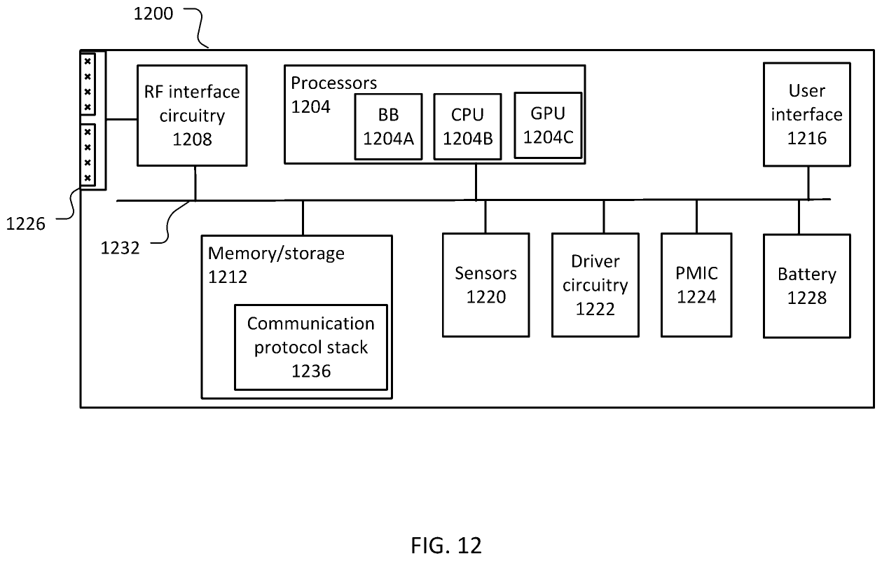

The signaling chart 400 may include a UE 402. The UE 402 may include one or more of the features of the UE 310 and/or the UE 1200 (FIG. 12). The signaling chart 400 may further include a base station 404. The base station may include one or more of the features of the base station 302 and/or the gNB 1300 (FIG. 13).

The UE 402 may perform a discovery operation 406 to search for cells that can provide service for the UE 402. For example, the UE 402 may be in an idle state and may initiate the discovery operation 406 to search for cells with which the UE 402 can establish a connection.

As part of the discovery operation 406, the UE 402 may transmit an inquiry 408 to the base station 404. For example, the UE 402 may be located within a cell hosted by the base station 404 and may transmit the inquiry 408 to the base station 404 based on the UE 402 being located within the cell. The inquiry 408 may request information related to the cell.

The base station 404 may transmit an SIB1 410 to the UE 402 in response to the inquiry 408. The SIB1 410 may be included in a message which can include one or more other information elements or can include just the SIB1 410. The SIB1 410 may include information related to capabilities of the cell related to the inquiry 408, including one or more of the features described as being included in an SIB1 in the approaches throughout this disclosure. The UE 402 may determine whether a cell is to be treated as a barred cell and/or whether an emergency call can be established with the barred cell based on the information with the SIB1 410.

While the SIB1 410 is described as being transmitted from the base station 404 to the UE 402 as part of the discovery operation 406 in the illustrated embodiment, it should be understood that the base station 404 can transmit the SIB1 410 including the features at different times in other embodiments and/or instances.

### Approaches Without NW signaling

A first approach (which can be referred to as Approach 1) may include allowing the (e)RedCap UE to access the cell ‘if’ the (e)RedCap bars the cell due to not supporting an Rx chain requirement. For example, the first approach can allow a RedCap UE or an eRedCap UE to utilize a barred cell for establishing an emergency call if the RedCap UE or the eRedCap UE is treating the barred cell as barred due to the barred cell not supporting an Rx chain requirement of the RedCap UE or the eRedCap UE. In some instances, the Rx chain requirement may be a 1Rx chain requirement. The technical specification may specify the ‘allowance’ separately for RedCap and eRedCap.

Further, the first approach may include allowing the (e)RedCap UE to access the cell ‘if’ the (e)RedCap bars the cell due to not supporting HD-FDD requirement. For example, the first approach can allow a RedCap UE or an eRedCap UE to utilize a barred cell for establishing an emergency call if the RedCap UE or the eRedCap UE is treating the barred cell as barred due to the barred cell not supporting an HD-FDD requirement of the RedCap UE or the eRedCap UE. The technical specification may specify the ‘allowance’ separately for RedCap and eRedCap.

For the first approach, the UE may receive an SIB1 (such as the SIB1 410) for the cell, such as during a discovery operation. The SIB1 may include a field (which may be an ims-EmergencySupport field) that indicates that the cell provides emergency support for emergency calls.

An example portion of section 5.3.1 of the technical specification 38.304 in accordance with approach 1 is provided in the paragraph below.

When cellBarredNTN is not broadcast in this cell,
For NTN access, the UE shall treat this cell as if cell status is “barred”.
   When cellBarredRedCap1Rx is indicated as “barred” in this cell, and the RedCap UE is equipped with 1Rx branch,
If ims-EmergencySupport is indicated as “true” in this cell, except for emergency calls, the RedCap UE shall treat this cell as if cell status is “barred”.
Otherwise the UE shall treat this cell as if cell status is “barred ”.
   When cellBarred-eRedCap1Rx is indicated as “barred” in this cell, and the eRedCap UE is equipped with 1Rx branch,
If ims-EmergencySupport is indicated as “true” in this cell, except for emergency calls, the eRedCap UE shall treat this cell as if cell status is “barred”.
Otherwise the UE shall treat this cell as if cell status is “barred”.
   When halfDuplexRedCapAllowed is not broadcast in this cell,
If ims-EmergencySupport is indicated as “true” in this cell, except for emergency calls, the (e)RedCap UE only capable of operating in half-duplex for FDD shall treat this cell as if cell status is “barred”.
Otherwise the UE shall treat this cell as if cell status is “barred”.

A second approach (which can be referred to as Approach 2 and is variant of approach 1) may allow the (e)RedCap UE to access the cell ‘if’ the (e)RedCap bars the cell due to not supporting Rx chain requirement. For example, the second approach can allow a RedCap UE or an eRedCap UE to utilize a barred cell for establishing an emergency call if the RedCap UE or the eRedCap UE is treating the barred cell as barred due to the barred cell not supporting an Rx chain requirement of the RedCap UE or the eRedCap UE. The technical specification may specify that the UE can assume itself to be compliant to the Rx requirement, just to place the emergency call.

The same logic may be applied for HD-FDD. For example, the second approach may include allowing the (e)RedCap UE to access the cell ‘if’ the (e)RedCap bars the cell due to not supporting HD-FDD requirement. For example, the second approach can allow a RedCap UE or an eRedCap UE to utilize a barred cell for establishing an emergency call if the RedCap UE or the eRedCap UE is treating the barred cell as barred due to the barred cell not supporting an HD-FDD requirement of the RedCap UE or the eRedCap UE. The technical specification may specify the ‘allowance’ separately for RedCap and eRedCap.

For the second approach, the UE may receive an SIB1 (such as the SIB1 410) for the cell, such as during a discovery operation. The SIB1 may include a field (which may be an ims-EmergencySupport field) that indicates that the cell provides emergency support for emergency calls.

An example portion of section 5.3.1 of the technical specification 38.304 in accordance with approach 2 is provided in the paragraph below.

When cell status “barred” is indicated or to be treated as if the cell status is “barred”,
The UE is not permitted to select/reselect this cell, not even for emergency calls except for the below cases:
   If the UE is RedCap UE and this UE treats the cell as barred due to not supporting the cellBarredRedCap1Rx requirement, the RedCap UE can consider the cell as acceptable cell only for emergency call only if ims-EmergencySupport is indicated as “true” in this cell.
   If the UE is eRedCap UE and this UE treats the cell as barred due to not supporting the cellBarred-eRedCap1Rx requirement, the eRedCap UE can consider the cell as acceptable cell only for emergency call only if ims-EmergencySupport is indicated as “true” in this cell.
   If the UE is (e)RedCap UE and this UE treats the cell as barred due to not supporting the hd-fdd-EmergencySupport requirement, the (e)RedCap UE can consider the cell as acceptable cell only for emergency call only if ims-EmergencySupport is indicated as “true” in this cell.
The UE shall select another cell according to the following rule:
If the cell is to be treated as if the cell status is “barred” due to being unable to acquire the MIB.

### Approaches With NW signaling

A third approach (which can be referred to as Approach 3 and is a variant of approach 1) may include allowing the (e)RedCap UE to access the cell ‘if’ the (e)RedCap bars the cell due to not supporting HD-FDD requirement only if the NW explicitly signals such support. For example, the third approach can allow a RedCap UE or an eRedCap UE to utilize a barred cell for establishing an emergency call if the RedCap UE or the eRedCap UE is treating the barred cell as barred due to the barred cell not supporting an HD-FDD requirement of the RedCap UE or the eRedCap UE and the NW provides an indication that the barred cell provides support for emergency calls with the HD-FDD requirement.

For the third approach, the UE may receive an SIB1 (such as the SIB1 410) for the cell, such as during a discovery operation. The SIB1 may include a field (which may be an hd-fdd-EmergencySupport field) that indicates whether the cell supports emergency calls with HD-FDD. Further, the SIB1 may include a field (which may be an ims-EmergencySupport field) that indicates that the cell provides emergency support for emergency calls.

An example portion of section 5.3.1 of the technical specification 38.304 in accordance with approach 1 is provided in the paragraph below.

When cellBarredNTN is not broadcast in this cell,
For NTN access, the UE shall treat this cell as if cell status is “barred”.
   When cellBarredRedCap1Rx is indicated as “barred” in this cell, and the RedCap UE is equipped with 1Rx branch,
If ims-EmergencySupport is indicated as “true” in this cell, except for emergency calls, the RedCap UE shall treat this cell as if cell status is “barred”.
Otherwise the UE shall treat this cell as if cell status is “barred”.
   When cellBarred-eRedCap1Rx is indicated as “barred” in this cell, and the eRedCap UE is equipped with 1Rx branch,
If ims-EmergencySupport is indicated as “true” in this cell, except for emergency calls, the eRedCap UE shall treat this cell as if cell status is “barred”.
Otherwise the UE shall treat this cell as if cell status is “barred”.
   When halfDuplexRedCapAllowed is not broadcast in this cell,
If ims-EmergencySupport is indicated as “true” in this cell, and if hd-fdd-EmergencySupport is indicated as “true”, except for emergency calls, the (e)RedCap UE only capable of operating in half-duplex for FDD shall treat this cell as if cell status is “barred”.
Otherwise the UE shall treat this cell as if cell status is “barred”.

A fourth approach (which can be referred to as Approach 4 and is variant of approach 2) may include allowing the (e)RedCap UE to access the cell ‘if’ the (e)RedCap only if the NW explicitly signals such support for HD-FDD. For example, the fourth approach can allow a RedCap UE or an eRedCap UE to utilize a barred cell for establishing an emergency call if the RedCap UE or the eRedCap UE is treating the barred cell as barred due to the barred cell not supporting an HD-FDD requirement of the RedCap UE or the eRedCap UE and the NW explicitly signaling support for HD-FDD.

For the fourth approach, the UE may receive an SIB1 (such as the SIB1 410) for the cell, such as during a discovery operation. The SIB1 may include a field (which may be an hd-fdd-EmergencySupport field) that indicates that the cell supports emergency calls with HD-FDD. Further, the SIB1 may include a field (which may be an ims-EmergencySupport field) that indicates that the cell provides emergency support for emergency calls.

An example portion of section 5.3.1 of the technical specification 38.304 in accordance with approach 4 is provided in the paragraph below.

When cell status “barred” is indicated or to be treated as if the cell status is “barred”,
The UE is not permitted to select/reselect this cell, not even for emergency calls except for the below cases:
   If the UE is RedCap UE and this UE treats the cell as barred due to not supporting the cellBarredRedCap1Rx requirement, the RedCap UE can consider the cell as acceptable cell only for emergency call only if ims-EmergencySupport is indicated as “true” in this cell.
   If the UE is eRedCap UE and this UE treats the cell as barred due to not supporting the cellBarred-eRedCap1Rx requirement, the eRedCap UE can consider the cell as acceptable cell only for emergency call only if ims-EmergencySupport is indicated as “true” in this cell.
   If the UE is (e)RedCap UE and this UE treats the cell as barred due to not supporting the hd-fdd-EmergencySupport requirement, the (e)RedCap UE can consider the cell as acceptable cell only for emergency call only if ims-EmergencySupport and hd-fdd-EmergencySupport are indicated as “true” in this cell.
The UE shall select another cell according to the following rule:
If the cell is to be treated as if the cell status is “barred” due to being unable to acquire the MIB.

A fifth approach (which can be referred to as Approach 5) may include allowing the NW to entirely control the whole EM call allowing procedure with an indication in SIB1. NW may signal a new field which allows the (e)RedCap UEs to consider placing the EM call on barred cells. The new field may apply on ‘all’ restrictions, including Rx requirement and HD-FDD requirement. In some embodiments, the NW may signal two separate fields, one field for allowing RedCap UEs and another field for allowing eRedCap UEs.

An example portion of section 5.3.1 of the technical specification 38.304 in accordance with approach 5 is provided in the paragraph below.

When cellBarredNTN is not broadcast in this cell,
For NTN access, the UE shall treat this cell as if cell status is “barred”.
   When cellBarredRedCap1Rx is indicated as “barred” in this cell, and the RedCap UE is equipped with 1Rx branch,
If ims-EmergencySupport is indicated as “true” and emergencySupportRedCap is indicated as “true” in this cell, except for emergency calls, the RedCap UE shall treat this cell as if cell status is “barred”.
Otherwise the UE shall treat this cell as if cell status is “barred”.
   When cellBarred-eRedCap1Rx is indicated as “barred” in this cell, and the eRedCap UE is equipped with 1Rx branch,
If ims-EmergencySupport is indicated as “true” and emergencySupportRedCap is indicated as “true” in this cell, except for emergency calls, the eRedCap UE shall treat this cell as if cell status is “barred”.
Otherwise the UE shall treat this cell as if cell status is “barred”.
   When halfDuplexRedCapAllowed is not broadcast in this cell,
If ims-EmergencySupport is indicated as “true” in this cell and emergencySupportRedCap is indicated as “true” in this cell, except for emergency calls, the (e)RedCap UE only capable of operating in half-duplex for FDD shall treat this cell as if cell status is “barred”.
Otherwise the UE shall treat this cell as if cell status is “barred”.

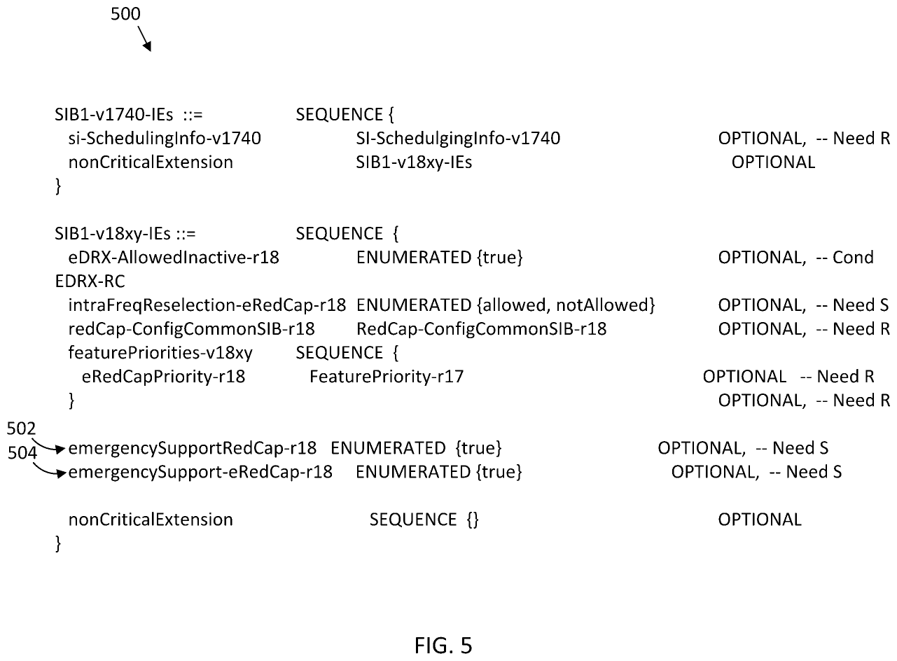

FIG. 5 illustrates an example SIB1 information element 500 related to approach 5 in accordance with some embodiments. The SIB1 information element 500 may be included in an SIB1 (such as the SIB1 410 (FIG. 4)) transmitted from a base station (such as the base station 404 (FIG. 4)) to a UE 402 (FIG. 4)) that can include information about a cell.

The SIB1 information element 500 may include a first field 502. The first field 502 may indicate whether the cell provides emergency support for emergency calls of RedCap UEs. In some embodiments, the first field 502 may be an emergencySupportRedCap-r18 field. The first field 502 may have a value of true to indicate that the cell provides emergency support for emergency calls of RedCap UEs or may have a value of false to indicate that the cell does not provide emergency support for emergency calls of RedCap UEs.

The SIB1 information element 500 may include a second field 504. The second field 504 may indicate whether the cell provides emergency support for emergency calls of eRedCap UEs. In some embodiments, the second field 504 may be an emergencySupport-eRedCap-r18 field. The second field 504 may have a value of true to indicate that the cell provides emergency support for emergency calls of eRedCap UEs or may have a value of false to indicate that the cell does not provide emergency support for emergency calls of eRedCap UEs.

The UE may utilize the values of the first field 502 or the second field 504 to determine whether the cell provides emergency support for emergency calls for the UE. For example, if the UE is a RedCap UE, the UE may determine that the cell supports emergency calls for the UE if the first field 502 has a value of true and may determine that the cell does not support emergency calls for the UE if the first field 502 has a value of false. If the UE is an eRedCap UE, the UE may determine that the cell supports emergency calls for the UE if the second field 504 has a value of true and may determine that the cell does not support emergency calls for the UE if the second field 504 has a value of false. In some embodiments, the SIB1 information element 500 may include one of the first field 502 and the second field 504 rather than including both fields.

A sixth approach (which can be referred to as Approach 6 and is a variant of Approach 5) may include allowing the NW to entirely control the whole EM call allowing procedure with an indication in SIB1. NW may signal a new field which allows the (e)RedCap UEs to consider placing the EM call on barred cells. The NW may include separate indications for Rx requirement and HD-FDD requirement. In some embodiments, the NW may signal two separate fields, one field for allowing RedCap UEs and another field for allowing eRedCap UEs.

An example portion of section 5.3.1 of the technical specification 38.304 in accordance with approach 6 is provided in the paragraph below.

When cellBarredNTN is not broadcast in this cell,
For NTN access, the UE shall treat this cell as if cell status is “barred”.
   When cellBarredRedCap1Rx is indicated as “barred” in this cell, and the RedCap UE is equipped with 1Rx branch,
If ims-EmergencySupport is indicated as “true” and emergencySupportRedCap is indicated as “true” in this cell, except for emergency calls, the RedCap UE shall treat this cell as if cell status is “barred”.
Otherwise the UE shall treat this cell as if cell status is “barred”.
   When cellBarred-eRedCap1Rx is indicated as “barred” in this cell, and the eRedCap UE is equipped with 1Rx branch,
If ims-EmergencySupport is indicated as “true” and emergencySupportRedCap is indicated as “true” in this cell, except for emergency calls, the eRedCap UE shall treat this cell as if cell status is “barred”.
Otherwise the UE shall treat this cell as if cell status is “barred”.
   When halfDuplexRedCapAllowed is not broadcast in this cell,
If ims-EmergencySupport is indicated as “true” in this cell and emergencySupport-Hd-FDD-RedCap is indicated as “true” in this cell, except for emergency calls, the (e)RedCap UE only capable of operating in half-duplex for FDD shall treat this cell as if cell status is “barred”.
Otherwise the UE shall treat this cell as if cell status is “barred”.

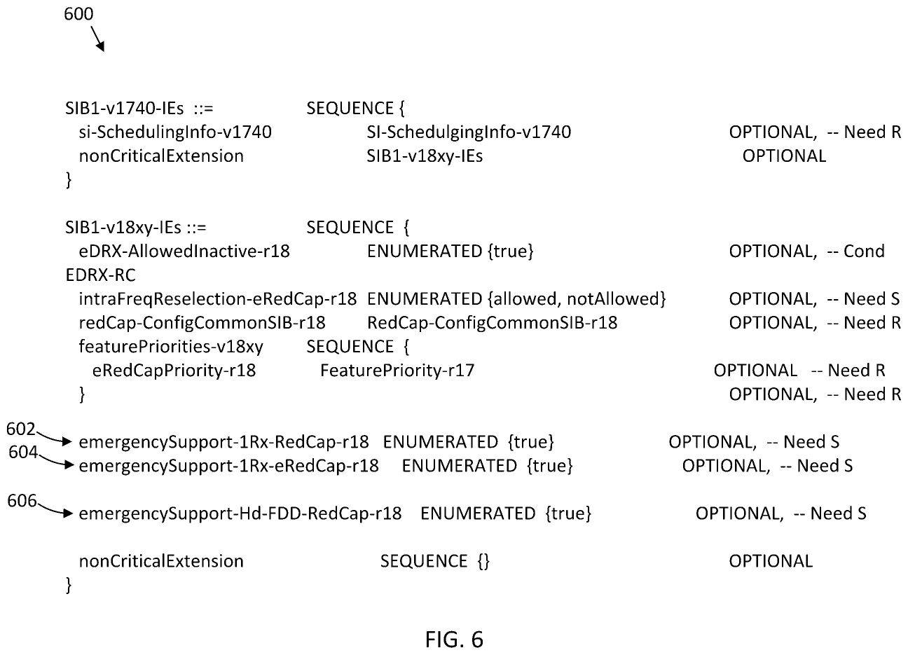

FIG. 6 illustrates an example SIB1 information element 600 related to approach 6 in accordance with some embodiments. The SIB1 information element 600 may be included in an SIB1 (such as the SIB1 410 (FIG. 4)) transmitted from a base station (such as the base station 404 (FIG. 4)) to a UE 402 (FIG. 4)) that can include information about a cell.

The SIB1 information element 600 may include a first field 602. The first field 602 may indicate whether the cell provides emergency support for emergency calls of RedCap UEs with 1Rx chain. In some embodiments, the first field 602 may be an emergencySupport-1Rx-RedCap-r18 field. The first field 602 may have a value of true to indicate that the cell provides emergency support for emergency calls of RedCap UEs with a 1Rx chain or may have a value of false to indicate that the cell does not provides emergency support for emergency calls or RedCap UEs with a 1Rx chain.

The SIB1 information element 600 may include a second field 604. The second field 604 may indicate whether the cell provides emergency support for emergency calls of eRedCap UEs with 1Rx chain. In some embodiments, the second field 604 may be an emergencySupport-1Rx-eRedCap-r18 field. The second field 604 may have a value of true to indicate that the cell provides emergency support for emergency calls of eRedCap UEs or may have a value of false to indicate that the cell does not provide emergency support for emergency calls of eRedCap UEs.

The SIB1 information element 600 may include a third field 606. The third field 606 may indicate whether the cell provides emergency support for emergency calls of UEs with HD-FDD. In some embodiments, the third field 606 may be an emergencySupport-Hd-FDD-RedCap-r18 field. The third field 606 may have a value of true to indicate that the cell provides emergency support for emergency calls of UEs with HD-FDD or may have a value of false to indicate that the cell does not provide emergency support for emergency calls of UEs with HD-FDD. In some embodiments, the SIB1 information element 600 may include one or more of the first field 602, the second field 604, or the third field 606 rather than including all three fields.

The UE may utilize the values of the first field 602, the second field 604, and/or the third field 606 to determine whether the cell provides emergency support for emergency calls for the UE. For example, if the UE is a RedCap UE with 1Rx chain, the UE may determine that the cell supports emergency calls for the UE if the first field 602 has a value of true and may determine that the cell does not support emergency calls for the UE if the first field 602 has a value of false. If the UE is an eRedCap UE with 1Rx chain, the UE may determine that the cell supports emergency calls for the UE if the second field 604 has a value of true and may determine that the cell does not support emergency calls for the UE if the second field 604 has a value of false. If the UE uses HD-FDD, the UE may determine that the cell supports emergency calls for the UE if the third field 606 has a value of true and may determine that the cell does not support emergency calls for the UE if the third field 606 has a value of false. In some embodiments, the UE may utilize more than one of the fields to determine whether cell supports emergency calls for the UE. For example, if the UE is a RedCap UE with 1Rx chain and uses HD-FDD, the UE may determine whether the cell supports emergency calls for the UE based on the values of the first field 602 and the third field 606.

### Approaches With NW Signaling—Further Restricted Access

A seventh approach (which can be referred to as Approach 7) may have a difference that the NW allows EM call access only ‘if’ the NW knows that there are no other cells in this frequency that support (e)RedCap UEs with the same 1Rx requirement (also the hd-fdd requirement). For example, the NW may allow emergency call access for a RedCap UE and/or a eRedCap UE with a 1Rx requirement and/or HD-FDD requirement via a cell operating within a frequency range if there are no other cells in the frequency range accessible to the UE that supports RedCap UEs and/or eRedCap UEs with 1Rx requirements and/or HD-FDD requirements. Since the NW knows that there are no other cells in this frequency, the NW allows such access. In other words, if there are other cells in the same frequency, the NW simply suggests that the UE perform a search for other cells in the same frequency for a suitable cell. Can be viewed as two separate fields, one field for allowing RedCap UEs (intraFreqReselectionRedCap-r17) and another field for allowing eRedCap UEs (intraFreqReselection-eRedCapr18).

An example portion of section 5.3.1 of the technical specification 38.304 in accordance with approach 7 is provided in the paragraph below.

When cellBarredNTN is not broadcast in this cell,
For NTN access, the UE shall treat this cell as if cell status is “barred”.
   When cellBarredRedCap1Rx is indicated as “barred” in this cell, and the RedCap UE is equipped with 1Rx branch,
If ims-EmergencySupport is indicated as “true” and intraFreqReselectionRedCap is indicated as “not allowed” in this cell, except for emergency calls, the RedCap UE shall treat this cell as if cell status is “barred”.
Otherwise the UE shall treat this cell as if cell status is “barred”.
   When cellBarred-eRedCap1Rx is indicated as “barred” in this cell, and the eRedCap UE is equipped with 1Rx branch,
If ims-EmergencySupport is indicated as “true” and intraFreqReselectioneRedCap is indicated as “not allowed” in this cell, except for emergency calls, the eRedCap UE shall treat this cell as if cell status is “barred”.
Otherwise the UE shall treat this cell as if cell status is “barred”.
   When halfDuplexRedCapAllowed is not broadcast in this cell,
If ims-EmergencySupport is indicated as “true” in this cell and intraFreqReselectionRedCap is indicated as “not allowed” in this cell, except for emergency calls, the RedCap UE only capable of operating in half-duplex for FDD shall treat this cell as if cell status is “barred”.
If ims-EmergencySupport is indicated as “true” in this cell and intraFreqReselection-eRedCap is indicated as “not allowed” in this cell, except for emergency calls, the eRedCap UE only capable of operating in half-duplex for FDD shall treat this cell as if cell status is “barred”.
Otherwise the UE shall treat this cell as if cell status is “barred”.

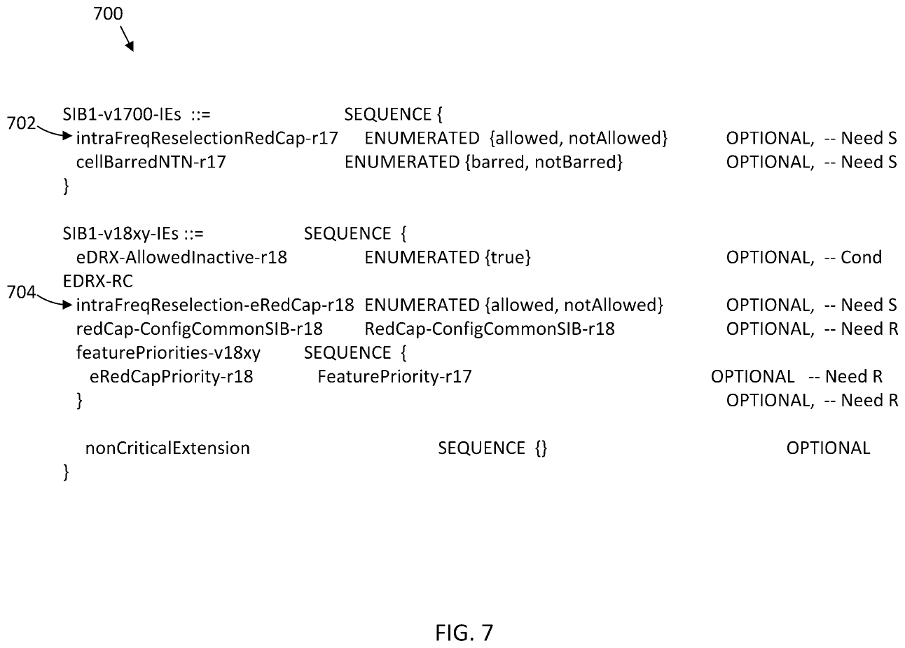

FIG. 7 illustrates an example SIB1 information element 700 related to approach 7 in accordance with some embodiments. The SIB1 information element 700 may be included in an SIB1 (such as the SIB1 410 (FIG. 4)) transmitted from a base station (such as the base station 404 (FIG. 4)) to a UE 402 (FIG. 4)) that can include information about a cell.

The SIB1 information element 700 may include a first field 702. The first field 702 may indicate whether a RedCap UE should search for other cells in the same frequency range that support requirements of the UE. In some embodiments, the first field 702 may be an intraFreqReselectionRedCap-r17 field. The first field 702 may have a value of allowed to indicate that the RedCap UE should search for other cells in the same frequency range, and a value of not allowed to indicate that the RedCap UE doe not need to search for other cells (which can indicate that the RedCap UE can utilize the cell for emergency calls).

The SIB1 information element 700 may include a second field 704. The second field 704 may indicate whether an eRedCap UE should search for other cells in the same frequency range that support requirements of the UE. In some embodiments, the second field 704 may be an intraFreqReselection-eRedCap-r18 field. The second field 704 may have a value of allowed to indicate that the eRedCap UE should search for other cells in the same frequency range, and a value of not allowed to indicate that the eRedCap UE doe not need to search for other cells (which can indicate that the eRedCap UE can utilize the cell for emergency calls). In some embodiments, the SIB1 information element 700 may include one of the first field 702 or the second field 704 rather than including both fields.

The UE may utilize the values of the first field 702 or the second field 704 to determine whether the cell provides emergency support for emergency calls for the UE or if the UE should search for other cells in the same frequency range. For example, if the UE is a RedCap UE, the UE may determine that the cell supports emergency calls for the UE if the first field 702 has a value of not allowed and may determine that the UE should search for other cells in the same frequency range if the first field 702 has a value of allowed. If the UE is an eRedCap UE, the UE may determine that the cell supports emergency calls for the UE if the second field 704 has a value of not allowed and may determine that the UE should search for other cells in the same frequency range if the second field 702 has a value of allowed. In some embodiments, the first field 702 and the second field 704 may be combined into a single field that can be used for both RedCap UEs and eRedCap UEs.

An eighth approach (which can be referred to as Approach 8) can be on top of approach 7 (which allows EM access if no other cell in the same frequency can support the UE). The NW can also control with a new flag that indicates whether the EM call can be placed. The flag can be a single new field, emergencySupport-r18, applicable to both RedCap and eRedCap. In other embodiments, the flag can be viewed as two separate fields, emergencySupportRedCap-r18 for allowing RedCap UEs (intraFreqReselectionRedCap-r17) and emergencySupport-eRedCap-r18 for allowing eRedCap UEs (intraFreqReselection-eRedCap-r18). The approach can also distinguish between Rx and HD-FDD requirement.

An example portion of section 5.3.1 of the technical specification 38.304 in accordance with approach 8 is provided in the paragraph below.

When cellBarredNTN is not broadcast in this cell,
For NTN access, the UE shall treat this cell as if cell status is “barred”.
   When cellBarredRedCap1Rx is indicated as “barred” in this cell, and the RedCap UE is equipped with 1Rx branch,
If ims-EmergencySupport is indicated as “true” and emergencySupportRedCap is indicated as “true” in this cell, and intraFreqReselectionRedCap is indicated as “not allowed” in this cell, except for emergency calls, the RedCap UE shall treat this cell as if cell status is “barred”.
Otherwise the UE shall treat this cell as if cell status is “barred”.
   When cellBarred-eRedCap1Rx is indicated as “barred” in this cell, and the eRedCap UE is equipped with 1Rx branch,
If ims-EmergencySupport is indicated as “true” and emergencySupportRedCap is indicated as “true” in this cell, and intraFreqReselection-eRedCap is indicated as “not allowed” in this cell, except for emergency calls, the eRedCap UE shall treat this cell as if cell status is “barred”.
Otherwise the UE shall treat this cell as if cell status is “barred”.
   When halfDuplexRedCapAllowed is not broadcast in this cell,
If ims-EmergencySupport is indicated as “true” in this cell and emergencySupport-Hd-FDD-RedCap is indicated as “true” in this cell, and intraFreqReselectionRedCap is indicated as “not allowed” in this cell, except for emergency calls, the RedCap UE only capable of operating in half-duplex for FDD shall treat this cell as if cell status is “barred”.
If ims-EmergencySupport is indicated as “true” in this cell and emergencySupport-Hd-FDD-RedCap is indicated as “true” in this cell and intraFreqReselectioneRedCap is indicated as “not allowed” in this cell, except for emergency calls, the eRedCap UE only capable of operating in half-duplex for FDD shall treat this cell as if cell status is “barred”. Otherwise the UE shall treat this cell as if cell status is “barred”.

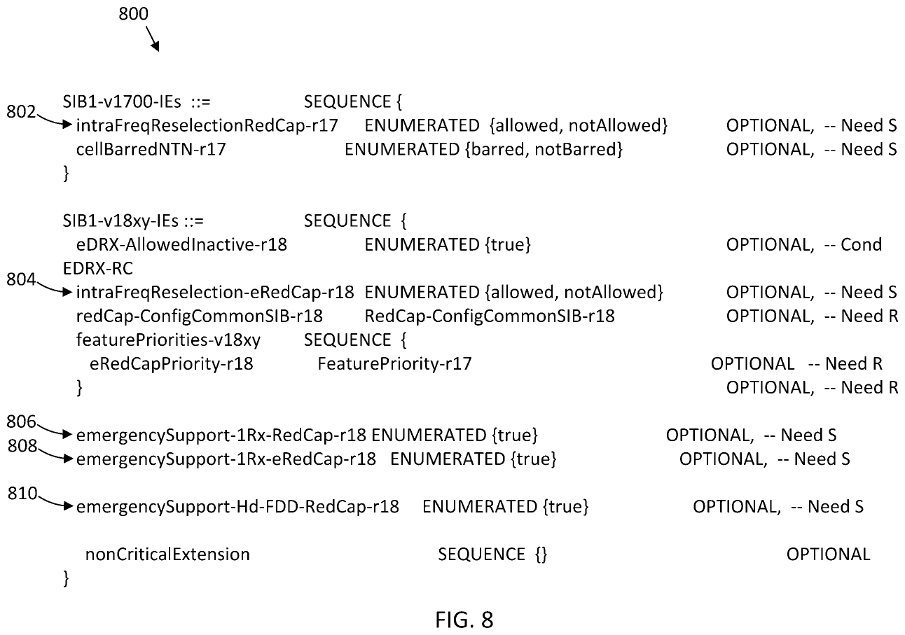

FIG. 8 illustrates an example SIB1 information element 800 related to approach 8 in accordance with some embodiments. The SIB1 information element 800 may be included in an SIB1 (such as the SIB1 410 (FIG. 4)) transmitted from a base station (such as the base station 404 (FIG. 4)) to a UE 402 (FIG. 4)) that can include information about a cell.

The SIB1 information element 800 may include a first field 802. The first field 802 may indicate whether a RedCap UE should search for other cells in the same frequency range that support requirements of the UE. In some embodiments, the first field 802 may be an intraFreqReselectionRedCap-r17 field. The first field 802 may have a value of allowed to indicate that the RedCap UE should search for other cells in the same frequency range, and a value of not allowed to indicate that the RedCap UE doc not need to search for other cells (which can indicate that the RedCap UE can utilize the cell for emergency calls).

The SIB1 information element 800 may include a second field 804. The second field 804 may indicate whether an eRedCap UE should search for other cells in the same frequency range that support requirements of the UE. In some embodiments, the second field 804 may be an intraFreqReselection-eRedCap-r18 field. The second field 804 may have a value of allowed to indicate that the eRedCap UE should search for other cells in the same frequency range, and a value of not allowed to indicate that the eRedCap UE doe not need to search for other cells (which can indicate that the RedCap UE can utilize the cell for emergency calls). In some embodiments, the first field 802 and the second field 804 may be combined into a single field that can be used for both RedCap UEs and eRedCap UEs.

The SIB1 information element 800 may include a third field 806. The third field 806 may indicate whether the cell provides emergency support for emergency calls of RedCap UEs with 1Rx chain. In some embodiments, the third field 806 may be an emergencySupport-1Rx-RedCap-r18 field. The third field 806 may have a value of true to indicate that the cell provides emergency support for emergency calls of RedCap UEs with a 1Rx chain or may have a value of false to indicate that the cell does not provides emergency support for emergency calls or RedCap UEs with a 1Rx chain.

The SIB1 information element 800 may include a fourth field 808. The fourth field 808 may indicate whether the cell provides emergency support for emergency calls of eRedCap UEs with 1Rx chain. In some embodiments, the fourth field 808 may be an emergencySupport-1Rx-eRedCap-r18 field. The fourth field 808 may have a value of true to indicate that the cell provides emergency support for emergency calls of eRedCap UEs or may have a value of false to indicate that the cell does not provide emergency support for emergency calls of eRedCap UEs.

The SIB1 information element 800 may include a fifth field 810. The fifth field 810 may indicate whether the cell provides emergency support for emergency calls of UEs with HD-FDD. In some embodiments, the fifth field 810 may be an emergencySupport-Hd-FDD-RedCap-r18 field. The fifth field 810 may have a value of true to indicate that the cell provides emergency support for emergency calls of UEs with HD-FDD or may have a value of false to indicate that the cell does not provide emergency support for emergency calls of UEs with HD-FDD.

In some embodiments, the third field 806 and the fourth field 808 may be combined into a single field that can be used for both RedCap UEs and eRedCap UEs with 1Rx chains. In some embodiments, the third field 806, the fourth field 808, and the fifth field 810 may be combined into a single field that can be used for both RedCap UEs and eRedCap UEs and for both 1Rx chain and HD-FDD. In some embodiments, the SIB1 information element 800 may include one or more of the first field 802, the second field 804, the third field 806, the fourth field 808, and/or the fifth field 810 rather than including all five fields.

The UE may utilize the values of the first field 802, the second field 804, the third field 806, the fourth field 808, and/or the fifth field 810 to determine whether the cell provides emergency support for emergency calls for the UE or if the UE should search for other cells in the same frequency range. For example, the UE may utilize the values of the first field 802 and the second field 804 to determine whether the UE should search for other cells in the same frequency range. If the UE is a RedCap UE, the UE may determine that the UE does not need to search for other cells if the first field 802 has a value of not allowed and may determine that the UE should search for other cells in the same frequency range if the first field 802 has a value of allowed. If the UE is an eRedCap UE, the UE may determine that the UE does not need to search for other cells if the second field 804 has a value of not allowed and may determine that the UE should search for other cells in the same frequency range if the second field 802 has a value of allowed.

The UE may utilize the values of the third field 806, the fourth field 808, and/or the fifth field 810 to determine whether the cell provides emergency support for emergency calls for the UE. For example, if the UE is a RedCap UE with 1Rx chain, the UE may determine that the cell supports emergency calls for the UE if the third field 806 has a value of true and may determine that the cell does not support emergency calls for the UE if the third field 806 has a value of false. If the UE is an eRedCap UE with 1Rx chain, the UE may determine that the cell supports emergency calls for the UE if the fourth field 808 has a value of true and may determine that the cell does not support emergency calls for the UE if the fourth field 808 has a value of false. If the UE uses HD-FDD, the UE may determine that the cell supports emergency calls for the UE if the fifth field 810 has a value of true and may determine that the cell does not support emergency calls for the UE if the fifth field 808 has a value of false. In some embodiments, the UE may utilize more than one of the fields to determine whether cell supports emergency calls for the UE. For example, if the UE is a RedCap UE with 1Rx chain and uses HD-FDD, the UE may determine whether the cell supports emergency calls for the UE based on the values of the third field 806 and the fifth field 810.

For example, if the UE is a RedCap UE, the UE may determine that the cell supports emergency calls for the UE if the first field 702 has a value of not allowed and may determine that the UE should search for other cells in the same frequency range if the first field 702 has a value of allowed. If the UE is an eRedCap UE, the UE may determine that the cell supports emergency calls for the UE if the second field 704 has a value of not allowed and may determine that the UE should search for other cells in the same frequency range if the second field 702 has a value of allowed. In some embodiments, the first field 702 and the second field 704 may be combined into a single field that can be used for both RedCap UEs and eRedCap UEs.

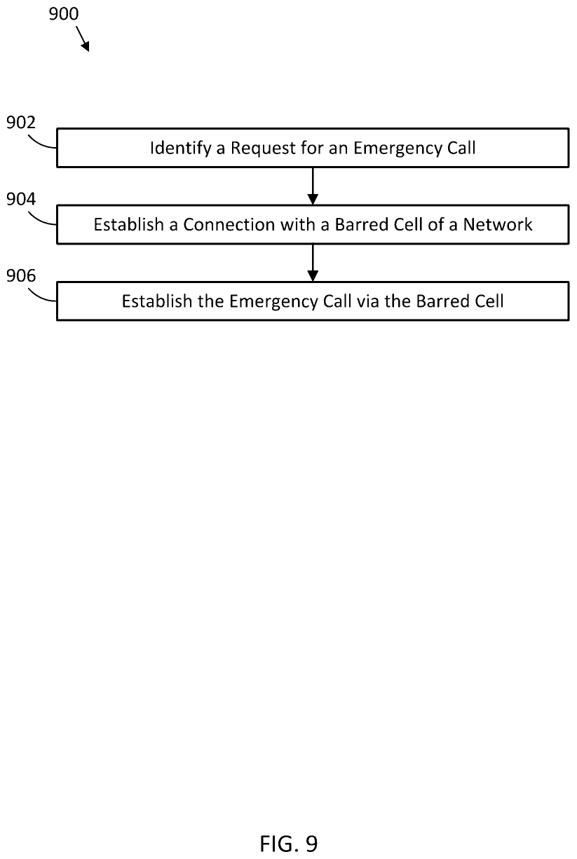

FIG. 9 illustrates an example procedure 900 in accordance with some embodiments. The procedure 900 may be performed by a UE, such as the UE 310 (FIG. 3), the UE 402 (FIG. 4), and/or the UE 1200 (FIG. 12). The UE may have reduced capability and may be a RedCap UE or an eRedCap UE.

The procedure 900 may include identifying a request for an emergency call in 902. For example, the UE may identify a request for an emergency call, where the request for the emergency call may be based on an input of a user of the UE.

The procedure 900 may include establishing a connection with a barred cell of a network in 904. For example, the UE may establish a connection with a barred cell of a network based at least in part on said identifying of the request for the emergency call.

In some embodiments, the procedure 900 may include identifying an indication for the barred cell that indicates the barred cell provides emergency support for UEs with reduced capability. The UE may establish the connection based at least in part on said identifying the indication.

In some embodiments, the procedure 900 may include identifying an indication for the barred cell that indicates intrafrequency reselection is not allowed. The UE may establish the connection based at least in part on said identifying the indication.

In some embodiments, the procedure 900 may include determining a reason for the UE treating the barred cell as barred. The procedure 900 may include identifying an indication for the barred cell that indicates that the barred cell provides emergency support for UEs treating the barred cell as barred for the reason in these embodiments. The UE may establish the connection based at least in part on said identifying the indication. In some of these embodiments, the reason may include the UE being only capable of operating in HD-FDD. Further, the indication may indicate that the barred cell provides emergency support for UEs treating the barred cell as barred for the UEs being only capable of operating in HD-FDD.

In some embodiments, the UE may be treating the barred cell as barred based at least in part on the barred cell not supporting a reception chain requirement of the UE. The UE may establish the connection based at least in part on the UE treating the barred cell as barred based at least in part on the barred cell not supporting the reception chain requirement of the UE.

In some embodiments, the UE may be treating the barred cell as barred based at least in part on the barred cell not supporting a HD-FDD requirement of the UE. The UE may establish the connection based at least in part on the UE treating the barred cell as barred based at least in part on the barred cell not supporting the HD-FDD requirement of the UE.

In some embodiments, the UE may treat the barred cell as barred for non-emergency calls. Further, the UE may treat the barred cell as acceptable for emergency calls.

In some embodiments, the UE may be a RedCap UE. The procedure 900 may include identifying an indication that the barred cell provides emergency support for RedCap UEs. The UE may establish the emergency call based at least in part on said identifying the indication.

In some embodiments, the UE may be an eRedCap UE. The procedure 900 may include identifying an indication that the barred cell provides emergency support for eRedCap UEs. The UE may establish the emergency call based at least in part on said identifying the indication.

The procedure 900 may include establishing the emergency call via the barred cell in 906. For example, the UE may establish the emergency call via the barred cell.

Although FIG. 9 arguably implies an order of the procedure 900, it should be understood that one or more of the operations may be performed in a different order and/or one or more of the operations may be performed concurrently in other embodiments. Further, it should be understood that one or more of the operations may be omitted from, and/or one or more additional operations may be added to, the procedure 900 in other embodiments.

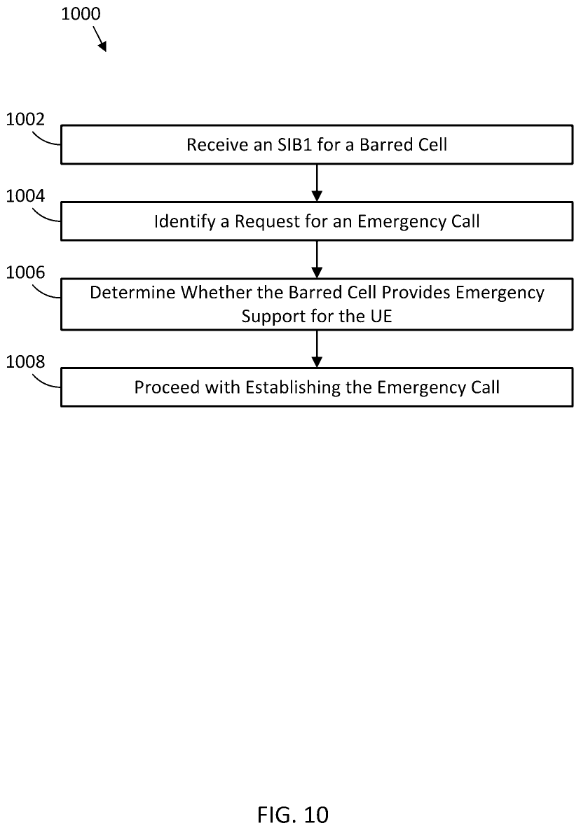

FIG. 10 illustrates an example procedure 1000 in accordance with some embodiments. The procedure 1000 may be performed by a UE, such as the UE 310 (FIG. 3), the UE 402 (FIG. 4), and/or the UE 1200 (FIG. 12). The UE may have reduced capability and may be a RedCap UE or an eRedCap UE.

The procedure 1000 may include receiving an SIB1 for a barred cell in 1002. For example, the UE may receive, from a base station, an SIB1 for a barred cell.

The procedure 1000 may include identifying a request for an emergency call in 1004. For example, the UE may identify a request for an emergency call, where the request for the emergency call may be based on an input of a user of the UE.

The procedure 1000 may include determining whether the barred cell provides emergency support for the UE in 1006. For example, the UE may determine whether the barred cell provides emergency support for the UE based at least in part on the SIB1.

In some embodiments, determining whether the barred cell provides emergency support for the UE may include determining that a field of the SIB1 indicates that the barred cell provides emergency support for emergency calls of UEs. Further, determining whether the barred cell provides emergency support for the UE may include determining that the barred cell provides emergency support for the UE based at least in part on the field of the SIB1 indicating that the barred cell provides emergency support for emergency calls of UEs.

In some embodiments, determining whether the barred cell provides emergency support for the UE may include determining that a field of the SIB1 indicates that the barred cell provides emergency support for emergency calls of UEs. Further, determining whether the barred cell provides emergency support for the UE may include treating the barred cell as acceptable for emergency calls based at least in part on the field of the SIB1 indicating that the barred cell provides emergency support for emergency calls of UEs.

In some embodiments, the UE may treat the barred cell as barred based at least in part on the barred cell not supporting HD-FDD. Determining whether the barred cell provides emergency support may include determining that a field of the SIB1 indicates that the barred cell provides emergency support for HD-FDD. Further, determining whether the barred cell provides emergency support may include determining that the barred cell provides emergency support for the UE based at least in part on the field of the SIB1 indicating that the barred cell provides emergency support for HD-FDD.

In some embodiments, the UE may treat the barred cell as barred based at least part on the barred cell not supporting HD-FDD. Determining whether the barred cell provides emergency support for the UE may include determining that a field of the SIB1 indicates that the barred cell provides emergency support for HD-FDD. Further, determining whether the barred cell provides emergency support for the UE may include treating the barred cell as acceptable for emergency calls based at least in part on the field of the SIB1 indicating that the barred cell provides emergency support for HD-FDD.

In some embodiments, the UE may be a RedCap UE. Determining whether the barred cell provides emergency support for the UE may include determining that a field of the SIB1 indicates that the barred cell provides emergency support for RedCap UEs. Determining whether the barred cell provides emergency support for the UE may include determining that the barred cell provides emergency support for the UE based at least in part on the field of the SIB1 indicating that the barred cell provides emergency support for RedCap UEs.

In some embodiments, the UE may be an eRedCap UE. Determining whether the barred cell provides emergency support for the UE may include determining that a field of the SIB1 indicates that the barred cell provides emergency support for eRedCap UEs. Further, determining whether the barred cell provides emergency support for the UE may include determining that the barred cell provides emergency support for the UE based at least in part on the field of the SIB1 indicating that the barred cell provides emergency support for eRedCap UEs.

In some embodiments, determining whether the barred cell provides emergency support for the UE may include determining that a field of the SIB1 indicates that intrafrequency reselection is not allowed. Further, determining whether the barred cell provides emergency support may include determining that the barred cell provides emergency support for the UE based at least in part on the field of the SIB1 indicating that intrafrequency reselection is not allowed.

In some embodiments, determining whether the barred cell provides emergency support for the UE may include determining that a field of the SIB1 indicates that intrafrequency reselection is not allowed. Further determining whether the barred cell provides emergency support for the UE may include determining that the barred cell provides emergency support for the UE based at least in part on the field of the SIB1 indicating that intrafrequency reselection is allowed.

The procedure 1000 may include proceeding with establishing the emergency call in 1008. For example, the UE may proceed with establishing the emergency call in accordance with said determining whether the barred cell provides emergency support for emergency calls of UEs with reduced capability.

In some embodiments, proceeding with establishing the emergency call may include establishing the emergency call with the barred cell based at least in part on said determining that the barred cell provides emergency support for the UE.

In some embodiments, proceeding with establishing the emergency call includes establishing the emergency call with the barred cell based at least in part on said treating the barred cell as acceptable for emergency calls.

In some embodiments, proceeding with establishing the emergency call may include identifying a second cell that provides emergency support for the UE based at least in part on the field of the SIB1 indicating that intrafrequency reselection is allowed. The second cell may be operating within a same frequency range as the barred cell. Further, proceeding with establishing the emergency call may include establishing the emergency call with the second cell.

Although FIG. 10 arguably implies an order of the procedure 1000, it should be understood that one or more of the operations may be performed in a different order and/or one or more of the operations may be performed concurrently in other embodiments. Further, it should be understood that one or more of the operations may be omitted from, and/or one or more additional operations may be added to, the procedure 1000 in other embodiments.

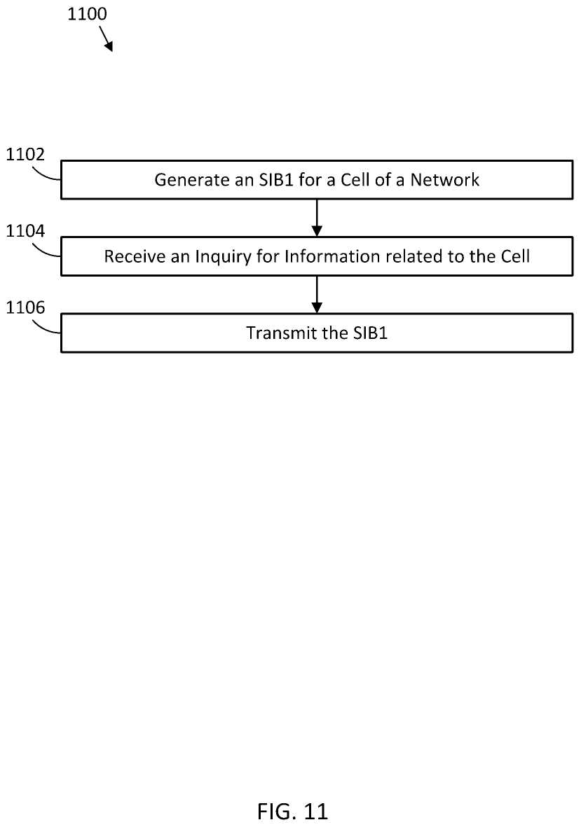

FIG. 11 illustrates an example procedure 1100 in accordance with some embodiments. The procedure 1100 may be performed by a base station, such as the base station 302 (FIG. 3), the base station 404 (FIG. 4), and/or the gNB 1300 (FIG. 13).

The procedure 1100 may include generating an SIB1 for a cell of a network in 1102. For example, the base station may generate an SIB1 for a cell of a network. The SIB1 may include at least one field related to emergency calls for UEs with reduced capability.

In some embodiments, the SIB1 may include a field that indicates whether the cell provides emergency support for HD-FDD. Further, the SIB1 may include a field that indicates whether the cell provides emergency support for RedCap UEs in some embodiments. In some embodiments, the SIB1 may include a field that indicates whether the cell provides emergency support for eRedCap UEs.

In some embodiments, the cell may be a first cell. The SIB1 may include a field that indicates whether the UE is to search for a second cell that operates in a same frequency range as the first cell to provide emergency support for emergency calls for the UE.

In some embodiment, the cell may be a first cell. The SIB1 may include a first field that indicates whether RedCap UEs are to search for another cell that operates in a same frequency range as the first cell to provide emergency support for emergency calls for RedCap UEs. In some of these embodiments, the SIB1 may include a second field that indicates whether eRedCap UEs are to search for another cell that operates in the same frequency range as the first cell to provide emergency support for emergency calls for eRedCap UEs.

The procedure 1100 may include receiving an inquiry for information related to the cell in 1104. For example, the base station may receive, from a UE, an inquiry for information related to the cell.

The procedure 1100 may include transmitting the SIB1 in 1106. For example, the base station may transmit, to the UE, the SIB1 based at least in part on the inquiry.

Although FIG. 11 arguably implies an order of the procedure 1100, it should be understood that one or more of the operations may be performed in a different order and/or one or more of the operations may be performed concurrently in other embodiments. Further, it should be understood that one or more of the operations may be omitted from, and/or one or more additional operations may be added to, the procedure 1100 in other embodiments.

FIG. 12 illustrates an example UE 1200 in accordance with some embodiments. The UE 1200 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices. In some embodiments, the UE 1200 may be a RedCap UE or NR-Light UE.

The UE 1200 may include processors 1204, RF interface circuitry 1208, memory/storage 1212, user interface 1216, sensors 1220, driver circuitry 1222, power management integrated circuit (PMIC) 1224, antenna structure 1226, and battery 1228. The components of the UE 1200 may be implemented as integrated circuits (ICs), portions thereof, discrete electronic devices, or other modules, logic, hardware, software, firmware, or a combination thereof. The block diagram of FIG. 12 is intended to show a high-level view of some of the components of the UE 1200. However, some of the components shown may be omitted, additional components may be present, and different arrangement of the components shown may occur in other implementations.

The components of the UE 1200 may be coupled with various other components over one or more interconnects 1232, which may represent any type of interface, input/output, bus (local, system, or expansion), transmission line, trace, optical connection, etc. that allows various circuit components (on common or different chips or chipsets) to interact with one another.

The processors 1204 may include processor circuitry such as, for example, baseband processor circuitry (BB) 1204A, central processor unit circuitry (CPU) 1204B, and graphics processor unit circuitry (GPU) 1204C. The processors 1204 may include any type of circuitry or processor circuitry that executes or otherwise operates computer-executable instructions, such as program code, software modules, or functional processes from memory/storage 1212 to cause the UE 1200 to perform operations as described herein.

In some embodiments, the baseband processor circuitry 1204A may access a communication protocol stack 1236 in the memory/storage 1212 to communicate over a 3GPP compatible network. In general, the baseband processor circuitry 1204A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 1208.

The baseband processor circuitry 1204A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 1212 may include one or more non-transitory, computer-readable media that includes instructions (for example, communication protocol stack 1236) that may be executed by one or more of the processors 1204 to cause the UE 1200 to perform various operations described herein. The memory/storage 1212 include any type of volatile or non-volatile memory that may be distributed throughout the UE 1200. In some embodiments, some of the memory/storage 1212 may be located on the processors 1204 themselves (for example, L1 and L2 cache), while other memory/storage 1212 is external to the processors 1204 but accessible thereto via a memory interface. The memory/storage 1212 may include any suitable volatile or non-volatile memory such as, but not limited to, dynamic random access memory (DRAM), static random access memory (SRAM), eraseable programmable read only memory (EPROM), electrically eraseable programmable read only memory (EEPROM), Flash memory, solid-state memory, or any other type of memory device technology.

The RF interface circuitry 1208 may include transceiver circuitry and radio frequency front module (RFEM) that allows the UE 1200 to communicate with other devices over a radio access network. The RF interface circuitry 1208 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 1226 and proceed to filter and amplify (with a low-noise amplifier) the signal. The signal may be provided to a receiver of the transceiver that down-converts the RF signal into a baseband signal that is provided to the baseband processor of the processors 1204.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna structure 1226.

In various embodiments, the RF interface circuitry 1208 may be configured to transmit/receive signals in a manner compatible with NR access technologies.

The antenna structure 1226 may include antenna elements to convert electrical signals into radio waves to travel through the air and to convert received radio waves into electrical signals. The antenna elements may be arranged into one or more antenna panels. The antenna structure 1226 may have antenna panels that are omnidirectional, directional, or a combination thereof to enable beamforming and multiple input, multiple output communications. The antenna structure 1226 may include microstrip antennas, printed antennas fabricated on the surface of one or more printed circuit boards, patch antennas, phased array antennas, etc. The antenna structure 1226 may have one or more panels designed for specific frequency bands including bands in FR1 or FR2.

The user interface 1216 includes various input/output (I/O) devices designed to enable user interaction with the UE 1200. The user interface 1216 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 1200.

The sensors 1220 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1222 may include software and hardware elements that operate to control particular devices that are embedded in the UE 1200, attached to the UE 1200, or otherwise communicatively coupled with the UE 1200. The driver circuitry 1222 may include individual drivers allowing other components to interact with or control various input/output (I/O) devices that may be present within, or connected to, the UE 1200. For example, driver circuitry 1222 may include a display driver to control and allow access to a display device, a touchscreen driver to control and allow access to a touchscreen interface, sensor drivers to obtain sensor readings of sensor circuitry 1220 and control and allow access to sensor circuitry 1220, drivers to obtain actuator positions of electro-mechanic components or control and allow access to the electro-mechanic components, a camera driver to control and allow access to an embedded image capture device, audio drivers to control and allow access to one or more audio devices.

The PMIC 1224 may manage power provided to various components of the UE 1200. In particular, with respect to the processors 1204, the PMIC 1224 may control power-source selection, voltage scaling, battery charging, or DC-to-DC conversion.

In some embodiments, the PMIC 1224 may control, or otherwise be part of, various power saving mechanisms of the UE 1200. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1200 may power down for brief intervals of time and thus save power. If there is no data traffic activity for an extended period of time, then the UE 1200 may transition off to an RRC_Idle state, where it disconnects from the network and does not perform operations such as channel quality feedback, handover, etc. The UE 1200 goes into a very low power state and it performs paging where again it periodically wakes up to listen to the network and then powers down again. The UE 1200 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1228 may power the UE 1200, although in some examples the UE 1200 may be mounted deployed in a fixed location, and may have a power supply coupled to an electrical grid. The battery 1228 may be a lithium ion battery, a metal-air battery, such as a zinc-air battery, an aluminum-air battery, a lithium-air battery, and the like. In some implementations, such as in vehicle-based applications, the battery 1228 may be a typical lead-acid automotive battery.

FIG. 13 illustrates an example gNB 1300 in accordance with some embodiments. The gNB 1300 may include processors 1304, RF interface circuitry 1308, core network (CN) interface circuitry 1312, memory/storage circuitry 1316, and antenna structure 1326.

The components of the gNB 1300 may be coupled with various other components over one or more interconnects 1328.

The processors 1304, RF interface circuitry 1308, memory/storage circuitry 1316 (including communication protocol stack 1310), antenna structure 1326, and interconnects 1328 may be similar to like-named elements shown and described with respect to FIG. 12.

The CN interface circuitry 1312 may provide connectivity to a core network, for example, a 5th Generation Core network (5GC) using a 5GC-compatible network interface protocol such as carrier Ethernet protocols, or some other suitable protocol. Network connectivity may be provided to/from the gNB 1300 via a fiber optic or wireless backhaul. The CN interface circuitry 1312 may include one or more dedicated processors or FPGAs to communicate using one or more of the aforementioned protocols. In some implementations, the CN interface circuitry 1312 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 may include a method of operating a user equipment (UE) with reduced capability, comprising identifying a request for an emergency call, establishing a connection with a barred cell of a network based at least in part on said identifying of the request for the emergency call, and establishing the emergency call via the barred cell.

Example 2 may include the method of example 1, comprising identifying an indication for the barred cell that indicates the barred cell provides emergency support for UEs with reduced capability, wherein the UE establishes the connection based at least in part on said identifying the indication.

Example 3 may include the method of example 1, comprising identifying an indication for the barred cell that indicates intrafrequency reselection is not allowed, wherein the UE establishes the connection based at least in part on said identifying the indication.

Example 4 may include the method of example 1, comprising determining a reason for the UE treating the barred cell as barred, and identifying an indication for the barred cell that indicates that the barred cell provides emergency support for UEs treating the barred cell as barred for the reason, wherein the UE establishes the connection based at least in part on said identifying the indication.

Example 5 may include the method of example 4, wherein the reason includes the UE being only capable of operating in half-duplex for frequency division duplex (HD-FDD), and wherein the indication indicates that the barred cell provides emergency support for UEs treating the barred cell as barred for the UEs being only capable of operating in HD-FDD.

Example 6 may include the method of example 1, wherein the UE is treating the barred cell as barred based at least in part on the barred cell not supporting a reception chain requirement of the UE, and wherein the UE establishes the connection based at least in part on the UE treating the barred cell as barred based at least in part on the barred cell not supporting the reception chain requirement of the UE.

Example 7 may include the method of example 1, wherein the UE is treating the barred cell as barred based at least in part on the barred cell not supporting a half-duplex frequency division duplex (HD-FDD) requirement of the UE, and wherein the UE establishes the connection based at least in part on the UE treating the barred cell as barred based at least in part on the barred cell not supporting the HD-FDD requirement of the UE.

Example 8 may include the method of example 1, wherein the UE treats the barred cell as barred for non-emergency calls, and wherein the UE treats the barred cell as acceptable for emergency calls.

Example 9 may include the method of example 1, wherein the UE with reduced capability is a reduced capability (RedCap) UE, and wherein the method comprises identifying an indication that the barred cell provides emergency support for RedCap UEs, wherein the UE establishes the emergency call based at least in part on said identifying the indication.

Example 10 may include the method of example 1, wherein the UE with reduced capability is an enhanced reduced capability (eRedCap) UE, and wherein the method comprises identifying an indication that the barred cell provides emergency support for eRedCap UEs, wherein the UE establishes the emergency call based at least in part on said identifying the indication.

Example 11 may include a method of operating a user equipment (UE) with reduced capability, comprising receiving, from a base station, a system information block 1 (SIB1) for a barred cell, identifying a request for an emergency call, determining whether the barred cell provides emergency support for the UE based at least in part on the SIB1, and proceeding with establishing the emergency call in accordance with said determining whether the barred cell provides emergency support for emergency calls of UEs with reduced capability.

Example 12 may include the method of example 11, wherein determining whether the barred cell provides emergency support for the UE includes determining that a field of the SIB1 indicates that the barred cell provides emergency support for emergency calls of UEs, and determining that the barred cell provides emergency support for the UE based at least in part on the field of the SIB1 indicating that the barred cell provides emergency support for emergency calls of UEs, and proceeding with establishing the emergency call includes establishing the emergency call with the barred cell based at least in part on said determining that the barred cell provides emergency support for the UE.

Example 13 may include the method of example 11, wherein determining whether the barred cell provides emergency support for the UE includes determining that a field of the SIB1 indicates that the barred cell provides emergency support for emergency calls of UEs, and treating the barred cell as acceptable for emergency calls based at least in part on the field of the SIB1 indicating that the barred cell provides emergency support for emergency calls of UEs, and proceeding with establishing the emergency call includes establishing the emergency call with the barred cell based at least in part on said treating the barred cell as acceptable for emergency calls.

Example 14 may include the method of example 11, wherein the UE treats the barred cell as barred based at least in part on the barred cell not supporting half-duplex for frequency division duplex (HD-FDD), and wherein determining whether the barred cell provides emergency support for the UE includes determining that a field of the SIB1 indicates that the barred cell provides emergency support for HD-FDD, and determining that determining that the barred cell provides emergency support for the UE based at least in part on the field of the SIB1 indicating that the barred cell provides emergency support for HD-FDD, and proceeding with establishing the emergency call includes establishing the emergency call with the barred cell based at least in part on said determining that the barred cell provides emergency support for the UE.

Example 15 may include the method of example 11, wherein the UE treats the barred cell as barred based at least in part on the barred cell not supporting half-duplex for frequency division duplex (HD-FDD), and wherein determining whether the barred cell provides emergency support for the UE includes determining that a field of the SIB1 indicates that the barred cell provides emergency support for HD-FDD, and treating the barred cell as acceptable for emergency calls based at least in part on the field of the SIB1 indicating that the barred cell provides emergency support for HD-FDD, and proceeding with establishing the emergency call includes establishing the emergency call with the barred cell based at least in part on said treating the barred cell as acceptable for emergency calls.

Example 16 may include the method of example 11, wherein the UE is a reduced capability (RedCap) UE, and wherein determining whether the barred cell provides emergency support for the UE includes determining that a field of the SIB1 indicates that the barred cell provides emergency support for RedCap UEs, and determining that the barred cell provides emergency support for the UE based at least in part on the field of the SIB1 indicating that the barred cell provides emergency support for RedCap UEs and proceeding with establishing the emergency call includes establishing the emergency call with the barred cell based at least in part on said determining that the barred cell provides emergency support for the UE.

Example 17 may include the method of example 11, wherein the UE is an enhanced reduced capability (eRedCap) UE, and wherein determining whether the barred cell provides emergency support for the UE includes determining that a field of the SIB1 indicates that the barred cell provides emergency support for eRedCap UEs, and determining that the barred cell provides emergency support for the UE based at least in part on the field of the SIB1 indicating that the barred cell provides emergency support for eRedCap UEs, and proceeding with establishing the emergency call includes establishing the emergency call with the barred cell based at least in part on said determining that the barred cell provides emergency support for the UE.

Example 18 may include the method of example 11, wherein determining whether the barred cell provides emergency support for the UE includes determining that a field of the SIB1 indicates that intrafrequency reselection is not allowed, and determining that the barred cell provides emergency support for the UE based at least in part on the field of the SIB1 indicating that intrafrequency reselection is not allowed, and proceeding with establishing the emergency call includes establishing the emergency call with the barred cell based at least in part on said determining that the barred cell provides emergency support for the UE.

Example 19 may include the method of example 11, wherein determining whether the barred cell provides emergency support for the UE includes determining that a field of the SIB1 indicates that intrafrequency reselection is not allowed, and determining that the barred cell provides emergency support for the UE based at least in part on the field of the SIB1 indicating that intrafrequency reselection is allowed, and proceeding with establishing the emergency call includes identifying a second cell that provides emergency support for the UE based at least in part on the field of the SIB1 indicating that intrafrequency reselection is allowed, the second cell operating within a same frequency range as the barred cell, and establishing the emergency call with the second cell.

Example 20 may include a method of operating a base station, comprising generating a system information block 1 (SIB1) for a cell of a network, the SIB1 including at least one field related to emergency calls for user equipments (UEs) with reduced capability, receiving, from a UE, an inquiry for information related to the cell, and transmitting, to the UE, the SIB1 based at least in part on the inquiry.

Example 21 may include the method of example 20, wherein the SIB1 includes a field that indicates whether the cell provides emergency support for half-duplex for frequency division duplex (HD-FDD).

Example 22 may include the method of example 20, wherein the SIB1 includes a field that indicates whether the cell provides emergency support for reduced capability (RedCap) UEs.

Example 23 may include the method of example 20, wherein the SIB1 includes a field that indicates whether the cell provides emergency support for enhanced reduced capability (eRedCap) UEs.

Example 24 may include the method of example 20, wherein the cell is a first cell, and wherein the SIB1 includes a field that indicates whether the UE is to search for a second cell that operates in a same frequency range as the first cell to provide emergency support for emergency calls for the UE.

Example 25 may include the method of example 20, wherein the cell is a first cell, and wherein the SIB1 includes a first field that indicates whether reduced capability (RedCap) UEs are to search for another cell that operates in a same frequency range as the first cell to provide emergency support for emergency calls for RedCap UEs, and a second field that indicates whether enhanced reduced capability (eRedCap) UEs are to search for another cell that operates in the same frequency range as the first cell to provide emergency support for emergency calls for eRedCap UEs.

Example 26 may include an apparatus comprising means to perform one or more elements of a method described in or related to any of examples 1-25, or any other method or process described herein.

Example 27 may include one or more non-transitory computer-readable media comprising instructions to cause an electronic device, upon execution of the instructions by one or more processors of the electronic device, to perform one or more elements of a method described in or related to any of examples 1-25, or any other method or process described herein.

Example 28 may include an apparatus comprising logic, modules, or circuitry to perform one or more elements of a method described in or related to any of examples 1-25, or any other method or process described herein.

Example 29 may include a method, technique, or process as described in or related to any of examples 1-25, or portions or parts thereof.

Example 30 may include an apparatus comprising: one or more processors and one or more computer-readable media comprising instructions that, when executed by the one or more processors, cause the one or more processors to perform the method, techniques, or process as described in or related to any of examples 1-25, or portions thereof.

Example 31 may include a signal as described in or related to any of examples 1-25, or portions or parts thereof.

Example 32 may include a datagram, information element, packet, frame, segment, PDU, or message as described in or related to any of examples 1-25, or portions or parts thereof, or otherwise described in the present disclosure.

Example 33 may include a signal encoded with data as described in or related to any of examples 1-25, or portions or parts thereof, or otherwise described in the present disclosure.

Example 34 may include a signal encoded with a datagram, IE, packet, frame, segment, PDU, or message as described in or related to any of examples 1-25, or portions or parts thereof, or otherwise described in the present disclosure.

Example 35 may include an electromagnetic signal carrying computer-readable instructions, wherein execution of the computer-readable instructions by one or more processors is to cause the one or more processors to perform the method, techniques, or process as described in or related to any of examples 1-25, or portions thereof.

Example 36 may include a computer program comprising instructions, wherein execution of the program by a processing element is to cause the processing element to carry out the method, techniques, or process as described in or related to any of examples 1-25, or portions thereof.

Example 37 may include a signal in a wireless network as shown and described herein.

Example 38 may include a method of communicating in a wireless network as shown and described herein.

Example 39 may include a system for providing wireless communication as shown and described herein.

Example 40 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1.-25. (canceled)

26. One or more non-transitory, computer-readable media having instructions that, when executed, cause processing circuitry to:
identify a request for an emergency call;
establish a connection with a barred cell of a network based at least in part on said identifying of the request for the emergency call; and
establish the emergency call via the barred cell.

27. The one or more non-transitory, computer-readable media of claim 26, wherein the instructions, when executed, further cause the processing circuitry to:
identify an indication for the barred cell that indicates the barred cell provides emergency support for user equipments (UEs) with reduced capability, wherein the connection is established based at least in part on said identifying the indication.

28. The one or more non-transitory, computer-readable media of claim 26, wherein the instructions, when executed, further cause the processing circuitry to:
identify an indication for the barred cell that indicates intrafrequency reselection is not allowed, wherein the connection is established based at least in part on said identifying the indication.

29. The one or more non-transitory, computer-readable media of claim 26, wherein the instructions, when executed, further cause the processing circuitry to:
determine a reason for a user equipment (UE) treating the barred cell as barred; and
identify an indication for the barred cell that indicates that the barred cell provides emergency support for UEs treating the barred cell as barred for the reason, wherein the connection is established based at least in part on said identifying the indication.

30. The one or more non-transitory, computer-readable media of claim 29, wherein the reason includes the UE being only capable of operating in half-duplex for frequency division duplex (HD-FDD), and wherein the indication indicates that the barred cell provides emergency support for UEs treating the barred cell as barred for the UEs being only capable of operating in HD-FDD.

31. The one or more non-transitory, computer-readable media of claim 26, wherein a user equipment (UE) is treating the barred cell as barred based at least in part on the barred cell not supporting a reception chain requirement of the UE, and wherein the connection is established based at least in part on the UE treating the barred cell as barred based at least in part on the barred cell not supporting the reception chain requirement of the UE.

32. The one or more non-transitory, computer-readable media of claim 26, wherein a user equipment (UE) is treating the barred cell as barred based at least in part on the barred cell not supporting a half-duplex frequency division duplex (HD-FDD) requirement of the UE, and wherein the connection is established based at least in part on the UE treating the barred cell as barred based at least in part on the barred cell not supporting the HD-FDD requirement of the UE.

33. The one or more non-transitory, computer-readable media of claim 26, wherein a user equipment (UE) treats the barred cell as barred for non-emergency calls, and wherein the UE treats the barred cell as acceptable for emergency calls.

34. The one or more non-transitory, computer-readable media of claim 26, wherein a user equipment (UE) with reduced capability is a reduced capability (RedCap) UE, and wherein the instructions, when executed, further cause the processing circuitry to:
identify an indication that the barred cell provides emergency support for RedCap UEs, wherein the UE establishes the emergency call based at least in part on said identifying the indication.

35. A method, comprising:
receiving, from a base station, a system information block 1 (SIB1) for a barred cell;
identifying a request for an emergency call;
determining whether the barred cell provides emergency support for a user equipment (UE) based at least in part on the SIB1; and
proceeding with establishing the emergency call in accordance with said determining whether the barred cell provides emergency support for emergency calls of UEs with reduced capability.

36. The method of claim 35, wherein:
determining whether the barred cell provides emergency support for the UE includes:
determining that a field of the SIB1 indicates that the barred cell provides emergency support for emergency calls of UEs; and
determining that the barred cell provides emergency support for the UE based at least in part on the field of the SIB1 indicating that the barred cell provides emergency support for emergency calls of UEs; and
proceeding with establishing the emergency call includes establishing the emergency call with the barred cell based at least in part on said determining that the barred cell provides emergency support for the UE.

37. The method of claim 35, wherein:
determining whether the barred cell provides emergency support for the UE includes:
determining that a field of the SIB1 indicates that the barred cell provides emergency support for emergency calls of UEs; and
treating the barred cell as acceptable for emergency calls based at least in part on the field of the SIB1 indicating that the barred cell provides emergency support for emergency calls of UEs; and
proceeding with establishing the emergency call includes establishing the emergency call with the barred cell based at least in part on said treating the barred cell as acceptable for emergency calls.

38. The method of claim 35, wherein the UE treats the barred cell as barred based at least in part on the barred cell not supporting half-duplex for frequency division duplex (HD-FDD), and wherein:
determining whether the barred cell provides emergency support for the UE includes:
determining that a field of the SIB1 indicates that the barred cell provides emergency support for HD-FDD; and
determining that determining that the barred cell provides emergency support for the UE based at least in part on the field of the SIB1 indicating that the barred cell provides emergency support for HD-FDD; and
proceeding with establishing the emergency call includes establishing the emergency call with the barred cell based at least in part on said determining that the barred cell provides emergency support for the UE.

39. The method of claim 35, wherein the UE is an enhanced reduced capability (eRedCap) UE, and wherein:
determining whether the barred cell provides emergency support for the UE includes:
determining that a field of the SIB1 indicates that the barred cell provides emergency support for eRedCap UEs; and
determining that the barred cell provides emergency support for the UE based at least in part on the field of the SIB1 indicating that the barred cell provides emergency support for eRedCap UEs; and
proceeding with establishing the emergency call includes establishing the emergency call with the barred cell based at least in part on said determining that the barred cell provides emergency support for the UE.

48. The method of claim 35, wherein:
determining whether the barred cell provides emergency support for the UE includes:
determining that a field of the SIB1 indicates that intrafrequency reselection is not allowed; and
determining that the barred cell provides emergency support for the UE based at least in part on the field of the SIB1 indicating that intrafrequency reselection is not allowed; and
proceeding with establishing the emergency call includes establishing the emergency call with the barred cell based at least in part on said determining that the barred cell provides emergency support for the UE.

41. The method of claim 35, wherein:
determining whether the barred cell provides emergency support for the UE includes:
determining that a field of the SIB1 indicates that intrafrequency reselection is not allowed; and
determining that the barred cell provides emergency support for the UE based at least in part on the field of the SIB1 indicating that intrafrequency reselection is allowed; and
proceeding with establishing the emergency call includes:
identifying a second cell that provides emergency support for the UE based at least in part on the field of the SIB1 indicating that intrafrequency reselection is allowed, the second cell operating within a same frequency range as the barred cell; and
establishing the emergency call with the second cell.

42. An apparatus, comprising:
processing circuitry to:
generating a system information block 1 (SIB1) for a cell of a network, the SIB1 including at least one field related to emergency calls for user equipments (UEs) with reduced capability;
receiving, from a UE, an inquiry for information related to the cell; and
transmitting, to the UE, the SIB1 based at least in part on the inquiry; and
interface circuitry coupled with the processing circuitry, the interface circuitry to enable communication.

43. The apparatus of claim 42, wherein the SIB1 includes a field that indicates whether the cell provides emergency support for half-duplex for frequency division duplex (HD-FDD).

44. The apparatus of claim 42, wherein the SIB1 includes a field that indicates whether the cell provides emergency support for reduced capability (RedCap) UEs.

45. The apparatus of claim 42, wherein the SIB1 includes a field that indicates whether the cell provides emergency support for enhanced reduced capability (eRedCap) UEs.
